(19) United States
(12) Patent Application Publication
(10) Pub. No.: US 2015/0060031 A1
(43) Pub. Date: Mar. 5, 2015

(54) PLATE HEAT EXCHANGER WITH HEAT EXCHANGER BLOCKS JOINED BY METAL FORM

(71) Applicant: LINDE AKTIENGESELLSCHAFT, Muenchen (DE)

(72) Inventors: Joerg DIETRICH, Erding (DE); Reinhold HOELZL, Geretsried (DE)

(73) Assignee: LINDE AKTIENGESELLSCHAFT, Muenchen (DE)

(21) Appl. No.: 14/468,727

(22) Filed: Aug. 26, 2014

(30) Foreign Application Priority Data
Aug. 29, 2013 (EP) 13004272.4

(51) Int. Cl. F28D 9/00; B23P 15/26; F28F 3/08

(52) U.S. Cl. CPC F28D 9/0062; F28F 3/08; B23P 15/26
USPC 165/166; 29/890.039

(57) ABSTRACT

The invention relates to a plate heat exchanger with at least two heat exchanger blocks. Each heat exchanger block has several sheets, arranged parallel to one another, that form a plurality of heat-exchange passages for fluids. The heat exchanger blocks are joined to one another via joining means and have at least one common header. A metal foam, that joins the outside surfaces of adjacent heat exchanger blocks to one another, is introduced into an interspace of adjacent heat exchanger blocks. In this way, a blanket heat-conductive and non-positive joining is provided between the opposing outside surfaces of adjacent heat exchanger blocks.

The invention relates to a plate heat exchanger with at least two heat exchanger blocks, each heat exchanger block having several sheets that are arranged parallel to one another and that form a plurality of heat-exchange passages for fluids that are involved in the heat exchange. The heat exchanger blocks are joined to one another via joining means and have at least one common header for distribution of a heat-exchanging fluid to the two heat exchanger blocks or for draining a heat-exchanging fluid from the two heat exchanger blocks.

Brazed plate heat exchangers made of aluminum are used in numerous installations at a variety of pressures and temperatures. They are used, for example, in the separation of air, the liquefaction of natural gas, and in installations for producing ethylene.

Such a plate heat exchanger is shown and described in, for example, “The Standards of the Brazed Aluminum Plate-Fin Heat Exchanger Manufactures Association” ALPEMA, Third Edition, 2010 on page 5. A figure taken from it is depicted in FIG. 1 as prior art and is described below.

The plate heat exchanger shown in FIG. 1 comprises several partitions 4 that are arranged in parallel to one another and that form a plurality of heat-exchange passages 1 for the media that are to be brought into heat exchange with one another. The heat-exchange passages 1 are closed to the outside by sheet metal strips 8, hereinafter also called sidebars 8, which are attached flush to the edge of the partitions 4. Within the heat-exchange passages 1, there are corrugated sheets 3, so-called fins 3. The partitions 4, fins 3, and sidebars 8 are permanently joined to one another and thus form a compact heat exchanger block 10. The entire heat exchanger block 10 is bordered on the outside by cover sheets 5.

For supply and drainage of the heat-exchanging media, semicylindrical collectors 7 with pipe connections 6, used to join feed and drainage pipelines, are attached via inlet and outlet openings 9 of the heat-exchange passages 1. The collectors 7 are also called headers 7 below. The inlet and outlet openings 9 of the heat exchanger passages 1 are formed by so-called distributor plates or distributor fins 2 that provide for a uniform distribution of the media within the individual heat-exchange passages 1. The media flow through the heat-exchange passages 1 in the channels formed by the fins 3 and the partitions 4.

The fins 3 are brazed at their contact sites to the partitions 4, as a result of which intensive heat-conductive contact between the fins 3 and the partitions 4 is established. In this way, the heat exchange between the different media that flow in alternation in adjacent heat-exchange passages 1 is improved.

These plate heat exchangers are preferably formed from aluminum, the components being joined to one another by brazing. The fins, partitions, distributor fins, cover sheets and sidebars, all provided with brazing, are stacked on one another and then brazed in a furnace to form a heat exchanger block. Then, the headers with pipe connections are welded onto the heat exchanger block.

In the production method just described the maximum size of the heat exchanger block is dictated by the size and geometry of the brazing furnace. Often, however, processes require a larger heat-exchange area and thus larger heat exchanger blocks than can be produced in this furnace. In order to satisfy these requirements, it is suggested on page 6 under 1.2.3 of the aforementioned publication that two or more heat exchanger blocks be joined to one another by welding in order to thus obtain an assembled heat exchanger block with increased stack height.

In order to produce a plate heat exchanger with several heat exchanger blocks, first two or more heat exchanger blocks are produced separately from one another from partitions, fins and distributor fins as described above in a brazing furnace. The latter still have no headers. Strips that end flush with the edges of the cover sheet are welded onto the cover sheet of a first heat exchanger block along the edges of the cover sheet. These strips that are often also called sidebars thus form more or less a frame on the cover sheet. A second heat exchanger block that is to be joined to the first heat exchanger block is placed with its cover sheet on the strips of the first heat exchanger block and is welded to them. The arrangement of two joined heat exchanger blocks has a greater stack height than the individual heat exchanger blocks that thus exceeds the size and geometry of the brazing furnace. Any number of heat exchanger blocks can be joined to one another in this way to form a heat exchanger block arrangement of any size. Then, the resulting heat exchanger block arrangement is provided with headers and pipe connections in order to obtain a large plate heat exchanger that comprises several heat exchanger blocks joined to one another.

Between the cover sheets of two adjacent heat exchanger blocks of such a plate heat exchanger, there is a cavity that is filled with air and that is surrounded by the sidebars. The media that are involved in the heat exchange do not flow through this cavity. The cavity is not pressurized.

In the various applications in these plate heat exchangers of made of several heat exchanger blocks, high stress concentrations occur in the transition region of the heat exchanger blocks.

An object of this invention is to make available a plate heat exchanger comprising several heat exchanger blocks and a method for its production, the plate heat exchanger having mechanical strength that is as great as possible and stresses in the transition region of the heat exchanger blocks are reduced.

Upon further study of the specification and appended claims, other objects, aspects and advantages of the invention will become apparent.

These objects are achieved by a plate heat exchanger in which a metal foam is present in the interspace between the opposing outside surfaces of adjacent heat exchanger blocks and the metal foam that joins these outside surfaces to one another. On the process side, these objects are achieved by a method wherein a liquid, hardenable metal foam is introduced into the interspace between the opposing outside surfaces of adjacent heat exchanger blocks, or a metal foam is formed in the interspace. Such a method can be applied in the manufacture of a plate heat exchanger having at least two heat exchanger blocks or can be applied in retrofitting an existing plate heat exchanger having at least two heat exchanger blocks.

Accordingly, a plate heat exchanger with at least two heat exchanger blocks is made available, each heat exchanger block having several sheets that are arranged parallel to one another and that form a plurality of heat-exchange passages for fluids involved in the heat exchange. The heat exchanger blocks are joined via joining means—such as, for example, the aforementioned edge-flush strips—and having at least one common header for distribution of a heat-exchanging fluid to the at least two heat exchanger blocks or for draining a heat-exchanging fluid from the at least two heat exchanger blocks. According to the invention, a metal foam joins the outside surfaces to one another in the interspace between opposing outside surfaces of adjacent heat exchanger blocks. This means that the previously air-filled cavity between the cover sheets of the heat exchanger blocks is preferably completely provided with metal foam.

The joining of the outside surfaces of the heat exchanger blocks according to the invention via a metal foam ensures a considerably larger joining area than is the case in the prior art. The outside surfaces of the heat exchanger blocks, which are generally formed by the cover sheets of the heat exchanger blocks, are joined by the metal foam in an integral and thus heat-conductive manner. The heat conduction enables an equalization of temperature differences between the adjacent heat exchanger blocks, as a result of which temperature-induced stresses between the heat exchanger blocks in the joining region or transition region of the heat exchanger blocks are reduced. A non-positive joining of the center region of the opposing outside surfaces is formed via the metal foam insert between the heat exchanger blocks. As a result, the mechanical strength of the heat exchanger block joining is improved. In this way, the operating reliability and fault tolerance or the service life of the plate heat exchanger is greatly increased.

Conversely, in a plate heat exchanger formed of several heat exchanger blocks, according to the prior art, the opposing outside surfaces of two adjacent heat exchanger blocks are joined to one another via the edge-flush strips only on the respective edges of the outside surfaces. Thus, a plate heat exchanger according to the prior art does not have any connections in the center region of the opposing outside surfaces. Accordingly, the thermal contact between two heat exchanger blocks due to the air-filled cavity is much poorer than the thermal contact between the heat-exchange passages within a heat exchanger block. In this way, temperature-induced clamping stresses arise on the outside edge weld at individual local sites. In the various applications, this can lead to high thermal stresses within the plate heat exchanger at the transition region of the heat exchanger blocks. This is prevented with the metal foam insert according to the invention.

Preferably, the metal foam is formed from aluminum or an aluminum alloy.

In one preferred embodiment, the metal foam roughly completely fills the interspace between the opposing outside surfaces of the heat exchanger blocks. Thus, over the entire outside surfaces of the heat exchanger blocks, there is heat-conductive contact, as a result of which temperature equalization between the heat exchanger blocks can take place optimally. It is also possible, however, to fill only partial regions of the interspace with foam. Preferably, however, the metal foam extends covers the center regions of the opposing outside surfaces of the heat exchanger blocks.

Preferably, the joining means, which joins the heat exchanger blocks to one another, is formed by strips that are each applied to opposing outside surfaces of the adjacent heat exchanger blocks, preferably by welding. The strips preferably end flush with the outside edges of the opposing outside surfaces of the heat exchanger blocks. Advantageously, the strips are welded to cover sheets of the heat exchanger modules via a continuous weld. The strips can form a peripheral frame on the outside surfaces of the heat exchanger blocks. During the production of the plate heat exchanger, first of all at least one opening to the interspace between the opposing outside surfaces should remain free for introducing the metal foam.

In the heat-exchange passages of the heat exchanger blocks, the plate heat exchanger according to the invention preferably has means for subdividing the heat-exchange passages into a plurality of channels. Preferably, they are corrugated sheets that can have different executions known to one skilled in the art. They are used to increase the heat conduction between the heat-exchange passages and to distribute the fluids uniformly over the heat-exchange passages. Moreover, they increase the mechanical strength of the heat exchanger block.

This invention also relates to a method for producing a plate heat exchanger with at least two heat exchanger blocks. Each of the heat exchanger block has several sheets that are arranged parallel to one another and that form a plurality of heat-exchange passages for fluids involved in the heat exchange.

The heat exchanger blocks are joined to one another via joining means—such as, for example, the aforementioned edge-flush strips. According to the invention, a liquid, hardenable metal foam is introduced into the interspace between opposing outside surfaces of adjacent heat exchanger blocks or is formed in the interspace.

Preferably, the metal foam is introduced into the interspace or formed in the interspace after the joining of the heat exchanger blocks via the joining means. Subsequent to the introduction or formation of the metal foam, the heat exchanger blocks are preferably provided with headers for distributing or draining the heat-exchanging fluids, preferably at least one common header at a time being applied to adjacent heat exchanger blocks.

Existing plate heat exchangers can also be retrofitted with this invention. Accordingly, a method for retrofitting a plate heat exchanger having at least two heat exchanger blocks is made available, in which each heat exchanger block has several sheets that are arranged parallel to one another and that form a plurality of heat-exchange passages for fluids involved in the heat exchange, the heat exchanger blocks being joined via joining means such as, for example, the above-described strips welded edge-flush and having at least one common header for distributing a heat-exchanging fluid to the two heat exchanger blocks or draining a heat-exchanging fluid from the two heat exchanger blocks. According to the invention, a liquid, hardenable metal foam is introduced into the interspace that is present between outside surfaces of adjacent heat exchanger blocks, and is heretofore generally filled with air, or the metal foam is formed within the interspace.

In the described method according to the invention, the introduction of the liquid metal foam can take place by one or more of the following processes: spraying-in, injecting, or suction.

One preferred embodiment of the method according to the invention calls for introducing the liquid metal foam using at least one spraying or injection device from at least one side of the heat exchanger blocks into the interspace and at the same time aspirating the metal foam on at least one other, preferably opposing, side of the heat exchanger blocks. Thus, it is possible to completely fill the interspace with metal foam, even in cases where there are only small access openings in the strip frame.

Between the outside surfaces of the heat exchanger blocks, which surfaces are to be joined, one or more parent substances can also be introduced that form a liquid, hardenable metal foam by mixing and/or by changing the ambient conditions, preferably the pressure and/or temperature. Preferably, the parent substances are in the form of a powder that forms a liquid, hardenable metal foam when exceeding or falling below a certain temperature and/or a certain pressure.

In a plate heat exchanger according to this invention, the mechanical and thermal joining between two adjacent heat exchanger blocks is clearly improved compared to the prior art. The entire plate heat exchanger block having several heat exchanger blocks is clearly a more rigid and mechanically more stable structure than a plate heat exchanger according to the prior art. In addition, a plate heat exchanger according to the invention has much better temperature equalization between two adjacent heat exchanger blocks. Within the scope of this invention, plate heat exchangers can be made available that comprise two or more than two, for example three or four, heat exchanger blocks. Since the mechanical strength of the joining between the individual heat exchanger blocks is increased compared to the prior art, plate heat exchangers can also be built that have of a larger number of blocks than was conventional and seemed feasible in the past.

The plate heat exchanger according to the invention can be used especially advantageously for methods that require an especially intensive heat contact between the outside surfaces of adjacent heat exchanger blocks. This is the case, for example, for steep temperature gradients, major changes in the temperature gradient, or for uneven distributions of the fluids participating in the heat exchange (improper distribution or maldistribution). These states can often occur in certain vaporization processes of two-phase mixtures or pure substances, for asymmetrical passage arrangement, unspecified operating states, and shutdown or start-up processes.

### BRIEF DESCRIPTION OF THE DRAWINGS

The invention is to be explained in more detail below using a prior art heat exchanger block and an embodiment of the invention shown in FIGS. 1 to 4 wherein:

FIG. 1 shows a prior art heat exchanger block;

FIG. 2 shows a perspective view of two heat exchanger blocks that are interconnected according to this invention,

FIG. 3 shows a cross-section through the arrangement of heat exchanger blocks according to FIG. 2 (line A-A) in the joining region of the two heat exchanger blocks; and

FIG. 4 shows a plate heat exchanger with the heat exchanger blocks shown in FIGS. 2 and 3.

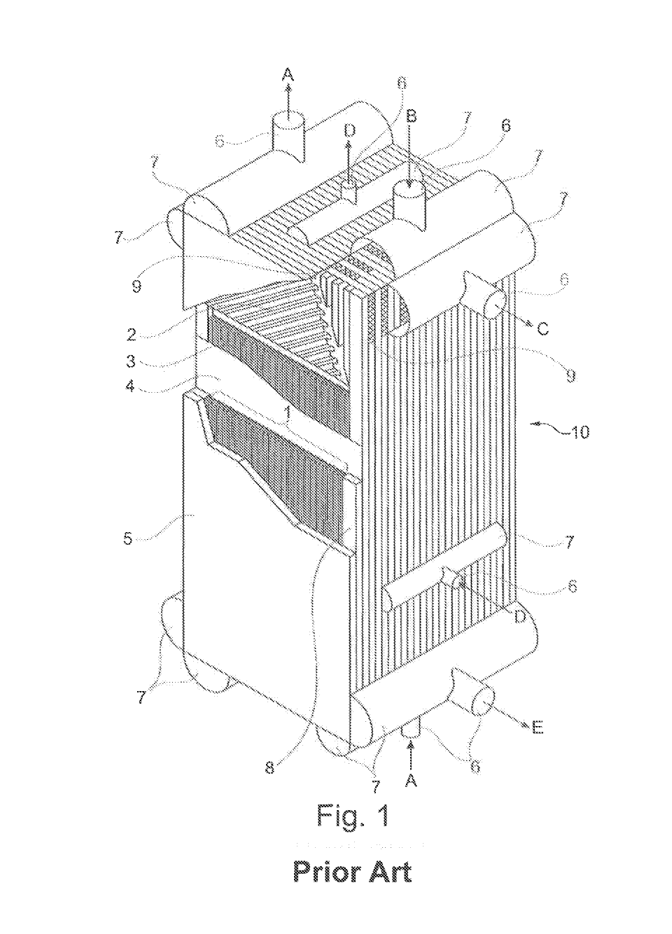

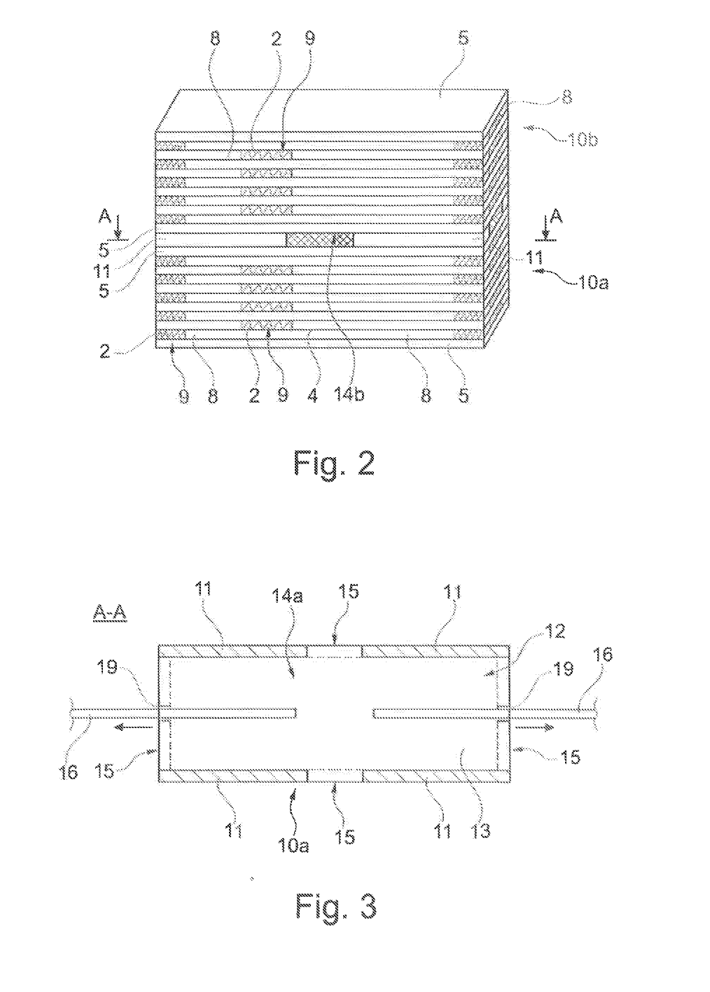

FIG. 2 shows two heat exchanger blocks 10a and 10b. The heat exchanger blocks, like the block 10 shown in FIG. 1, comprise a plurality of flat sheets 4, hereinafter also called partitions 4, which are arranged in a stack in parallel and at a distance to one another. On the partitions 4, there are sheet metal strips 8 arranged flush on their outside edges, which strips fix the distance between the partitions 4 and hereinafter are also called sidebars 8. This structure between the partitions 4 forms a plurality of heat-exchange passages 1 that are available for indirect heat exchange of two or more fluids. The sidebars 8 close the heat-exchange passages 1 to the outside.

Within the heat-exchange passages 1, corrugated sheets 3, so-called fins 3, are arranged. The latter are not apparent in FIG. 3 since fins 3 are located within the heat-exchange blocks 10a and 10b, not in the joining region. Reference is therefore made to FIG. 1 that shows fins 3 in an elevation of the heat-exchange block 10. At inlet and outlet openings 9 of the heat exchanger passages 1, there are so-called distributor plates or distributor fins 2 that provide for a uniform distribution of the fluids over the flow cross-sections of the individual heat-exchange passages 1. In the illustrated view, the two heat exchanger blocks 10a and 10b are each bordered to the outside to the top and bottom by cover sheets 5. The cover sheets 5 generally have a greater material thickness than the partitions 4 that are located within the heat exchanger blocks 10a and 10b. As material for the indicated components of the heat exchanger blocks 10a and 10b, an aluminum alloy, for example aluminum alloy 3003 or 5083, is used. The heat exchanger blocks 10a and 10b can, however, also be produced from high-grade steel.

To produce the heat exchanger blocks 10a and 10b, the brazing metal-plated partitions 4, the fins 3, the distributor fins 2 and the sidebars 8 are first stacked in alternation on one another. Then, the arrangement is brazed in a brazing furnace. After brazing, all of the above-mentioned components are securely joined to one another and thus form compact cuboidal heat exchanger blocks 10a and 10b. The two heat exchanger blocks 10a and 10b are brazed separately from one another. They have two dimensions that constitute maximum dimensions for a conventional brazing furnace interior. If, for certain installations and processes, heat-exchange areas are required that are larger than a heat exchanger block of maximum possible brazing furnace size can make available, two or more heat exchanger blocks are joined to one another according to this invention.

In addition to FIG. 2, reference is also made to FIG. 3 below.

After separate fabrication of the heat exchanger blocks 10a and 10b, metallic joining strips 11 that end flush with the edges of the cover sheet 5 are welded onto the cover sheet 5 of one of the heat exchanger blocks, for example, the a prior art heat exchanger block heat exchanger block 10a, along the edges of the cover sheet 5. The joining strips 11 generally have roughly the same material thickness as the sheet metal strips or sidebars 8 that are used within the heat exchanger blocks 10a and 10b.

The heat exchanger block 10b that is to be joined to the heat exchanger block 10a is placed with its cover sheet 5 on the joining strips 11 of the heat exchanger block 10a. In doing so, the heat exchanger block 10b is arranged exactly flush with the heat exchanger block 10a. This is important for the following application of common headers to the two heat exchanger blocks 10a and 10b.

Then, the joining strips 11 are welded to the heat exchanger block 10b along the edges of the cover sheet 5. In this way, the two blocks 10a and 10b are securely joined to one another. The arrangement of two heat exchanger blocks 10a and 10b has a larger stack height than the individual heat exchanger blocks themselves, which thus exceeds the size and geometry of the brazing furnace. In this way, any number of heat exchanger blocks can be joined to one another into a heat exchanger block arrangement of any size with increased heat-exchange area.

Between the cover sheets 5 of the heat exchanger blocks 10a and 10b that have been welded to one another, an interspace 12 is formed that is then filled at this point with a metal foam 13. The metal foam 13 is formed from aluminum or an aluminum alloy.

Various possibilities are listed below for the manner in which the metal foam can be introduced into the interspace 12, which possibilities can be used individually or in a variety of combinations:

Injecting the liquid metal foam at one or more sites with an injection apparatus;

Spraying-in the liquid metal foam at one or more sites with a spraying apparatus;

Delivering one or more solid or liquid parent substances, for example in powder form into the interspace, that can form a metal foam when exceeding or falling below a certain pressure and/or a certain temperature;

Injecting or spraying-in the liquid metal foam at one or more sites and sucking out the liquid metal foam at one or more other, preferably opposing, sites.

In this embodiment, two spray apparatuses 16 are introduced into the interspace 12 from two opposing sides of the heat exchanger blocks 10a and 10b through openings 15 that remain open to the interspace 12 between the joining strips 11. These apparatuses are gradually pulled out of the interspace in the direction of the arrow while the liquid metal foam is being sprayed-in. In this way, the liquid metal foam 13 is uniformly distributed in the interspace 12. After the metal foam 13 hardens, the metal foam that has emerged from the interspace 12 via the openings 19 is removed from the heat exchanger block arrangement.

As can be seen from FIG. 3, the hardened or solidified metal foam 13 fills the entire interspace 12 between the opposing outside surfaces 14a and 14b of the two heat exchanger blocks 10a and 10b. Thus, a flat joining is provided between the outside surfaces 14a and 14b of the opposing cover sheets 5. The metal foam 13 forms a heat bridge, as a result of which thermally-conductive contact is formed between the opposing cover sheets 5 of the heat exchanger blocks 10a and 10b. The thermally-conductive joining provides a thermally-conductive contact that extends over the entire cover sheet surface between the heat exchanger blocks 10a and 10b. Temperature differences between the blocks 10a and 10b can thus be diminished, as a result of which temperature-induced stresses are reduced.

Moreover, the two heat exchanger blocks 10a and 10b are non-positively joined to one another in a blanket manner by the metal foam 13, as a result of which the mechanical strength of the heat exchanger block joining is improved relative to a joining that in the past has existed only on the edge over the metal joining strips 11.

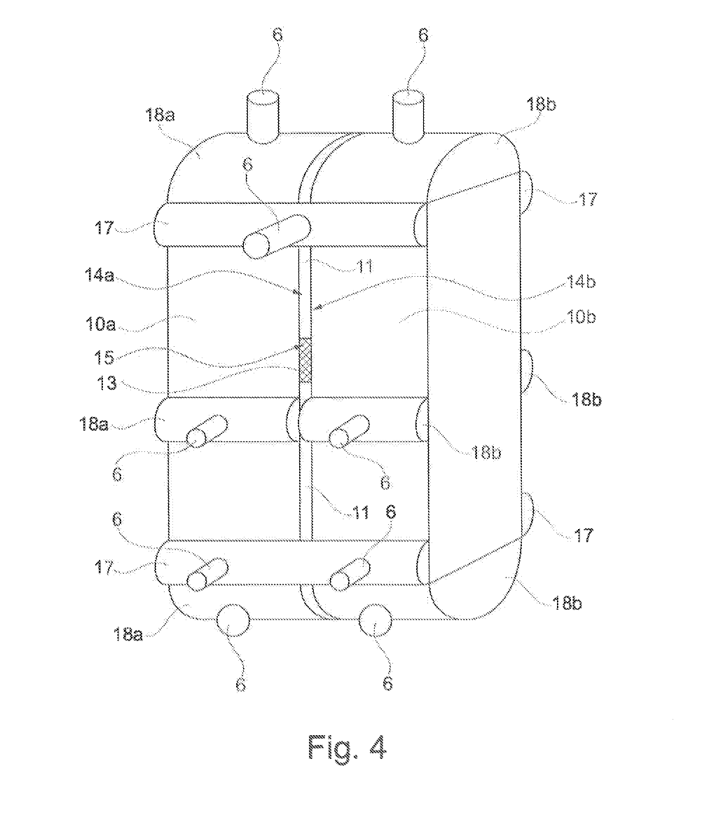

In this embodiment, the two blocks 10a and 10b are welded to one another via four joining strips 11. The number and arrangement of the joining strips 11 can differ from the embodiment that is shown in FIGS. 2 and 3. An almost peripherally-closed attachment of joining strips 11 is possible. To deliver the liquid metal foam or parent substances for its formation, it is, however, necessary that at least one opening 15 to the interspace 12 remains open. The joining strips 11 are generally required where common headers for the two blocks 10 a and 10 b are provided, as shown in FIG. 4, in order to ensure a fluid-tight seal of the headers to the interspace 12 in the joining region of the two blocks.

As shown in FIG. 4, after joining the two heat exchanger blocks 10a and 10b, common headers 17, separate headers 18a and 18b, all with pipe connections 6, are applied to the heat exchanger blocks 10 and 10b by welding. The latter are used to distribute or collect the fluids involved in the heat exchange.

Also, a plate heat exchanger, as shown in FIG. 4, which is finally already completed and which has possibly already been started up, can be retrofitted with a metal foam insert for joining the heat exchanger blocks 10a and 10b. If there is no opening 15 to the interspace 12, since, for example, the joining strips 11 form a peripherally closed frame (see FIG. 3 shown in broken lines), it is possible to make one or more bores 19 (see FIG. 3) in the joining strips 11. Then, liquid metal foam or corresponding parent substances can be delivered into the interspace through these bores. The bores are then sealed fluid-tight again, if necessary, for example by welding.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding European patent application EP 13004272.4, filed Aug. 29, 2013, are incorporated by reference herein.

Reference Symbol List

| | |
|---|---|
| Heat-exchange passage | 1 |
| Distributor fin | 2 |
| lamella, fin | 3 |
| Partition | 4 |
| Cover sheet | 5 |
| Pipe connection | 6 |
| Collector, header | 7 |
| Sidebar | 8 |
| Inlet or outlet opening | 9 |
| Heat exchanger block | 10, 10a, 10b |
| Joining strip | 11 |
| Interspace | 12 |
| Metal foam | 13 |
| Outside surface | 14a, 14b |
| Opening to interspace 12 | 15 |
| Spray apparatus | 16 |
| Common header | 17 |
| Separate header | 18a, 18b |
| bore in joining strip 11 | 19 |

1. A plate heat exchanger comprising:
at least two heat exchanger blocks (10a, 10b), each heat exchanger block (10a, 10b) having several sheets (4) that are arranged parallel to one another and that form a plurality of heat-exchange passages (1) for fluids that are involved in the heat exchange,
said at least two heat exchanger blocks (10a, 10b) being joined to one another via joining means (11) and having at least one common header (17) for distribution of a heat-exchanging fluid to the said at least two heat exchanger blocks (10a, 10b) or for draining a heat-exchanging fluid from said at least two heat exchanger blocks (10a, 10b),
wherein a metal foam (13) joins the outside surface (14a) of a heat exchange block to the outside surface (14b) of an adjacent heat exchange block in an interspace (12) between the adjacent heat exchanger blocks (10a, 10b) that is present between the outside surfaces (14a, 14b) of the adjacent heat exchanger blocks.

2. The plate heat exchanger according claim 1, wherein the metal foam (13) is formed from aluminum or an aluminum alloy.

3. The plate heat exchanger according to claim 1, wherein the metal foam (13) covers the center region of the opposing outside surfaces (14a, 14b) of the adjacent heat exchanger blocks (10a, 10b).

4. The plate heat exchanger according to claim 1, wherein the metal foam (13) roughly completely fills the interspace (12) between the opposing outside surfaces (14a, 14b) of the adjacent heat exchanger blocks.

5. The plate heat exchanger according to claim 1, wherein the metal foam (13) completely fills the interspace (12) between the opposing outside surfaces (14a, 14b) of the adjacent heat exchanger blocks.

6. The plate heat exchanger according to claim 1, wherein said joining means (11) are formed by strips (11) that are each applied to said opposing outside surfaces (14a, 14b) of adjacent heat exchanger blocks (10a, 10b).

7. The plate heat exchanger according to claim 6, wherein said strips (11) applied to said opposing outside surfaces (14a, 14b) of adjacent heat exchanger blocks (10a, 10b) by welding.

8. The plate heat exchanger according to claim 1, wherein in the heat-exchange passages (1) of the heat exchanger blocks (10a, 10b), means (3) are arranged for subdividing the heat-exchange passages (1) into a plurality of channels

9. The plate heat exchanger according to claim 8, wherein the means (3) for subdividing the heat-exchange passages (1) into a plurality of channels are corrugated sheets (3).

10. A method for producing a plate heat exchanger comprising at least two heat exchanger blocks (10a, 10b), each heat exchanger block (10a, 10b) having several sheets (4) that are arranged parallel to one another and that form a plurality of heat-exchange passages (1) for fluids involved in the heat exchange, the at least two heat exchanger blocks (10a, 10b) being joined to one another via joining means (11), said method comprising:
introducing a liquid, hardenable metal foam (13) into an interspace (12) between opposing outside surfaces (14a, 14b) of adjacent heat exchanger blocks (10a, 10b), or
a metal foam (13) is formed in the interspace (12) between opposing outside surfaces (14a, 14b) of adjacent heat exchanger blocks (10a, 10b).

11. The method according to claim 10, wherein the metal foam (13) is introduced into the interspace (12) or formed in the interspace (12) after the joining of the at least two heat exchanger blocks (10a, 10b) via the joining means (11).

12. The method according to claim 10, wherein, after introducing or forming the metal foam (13), the heat exchanger blocks (10a, 10b) are provided with headers (17, 18a, 18b) for distributing and collecting heat-exchanging fluids into or out of one part of the heat-exchange passages (1) at a time, at least one common header (17) being applied to adjacent heat exchanger blocks (10a, 10b) for distributing a heat-exchanging fluid to the adjacent heat exchanger blocks (10a, 10b) or for draining a heat-exchanging fluid from the adjacent heat exchanger blocks (10a, 10b).

13. A method for retrofitting a plate heat exchanger having at least two heat exchanger blocks (10a, 10b), each heat exchanger block (10a, 10b) having several sheets (4) that are arranged parallel to one another and that form a plurality of heat-exchange passages (1) for fluids involved in the heat exchange, the at least two heat exchanger blocks (10a, 10b) being joined via joining means (11) and having at least one common header (17) for distributing a heat-exchanging fluid to the at least two heat exchanger blocks (10a, 10b) or for draining a heat-exchanging fluid from the at least two heat exchanger blocks (10a, 10b), said method comprising:
introducing a liquid, hardenable metal foam (13) into an interspace (12) between the outside surfaces (14a, 14b) of adjacent heat exchanger blocks (10a, 10b), or a metal foam (13) is formed in the interspace (12) between opposing outside surfaces (10-4a, 14b) of adjacent heat exchanger blocks (10a, 10b).

14. The method according to claim 10, wherein the introduction of the liquid metal foam (13) can take place by one or more of the following processes: spraying-in, injecting, or suction.

15. The method according to claim 10, wherein the liquid metal foam (13) is delivered into the interspace (12) using at least one spraying or injection device from at least one side of the heat exchanger blocks (10a, 10b), and at the same time is aspirated from at least one other side of the heat exchanger blocks (10a, 10b), especially the opposing side.

16. The method according to claim 10, wherein between the outside surfaces (14a, 14b) of the heat exchanger blocks (10a, 10b), which surfaces are to be joined, one or more parent substances are introduced that form a liquid, hardenable metal foam (13) by mixing and/or by changing the ambient conditions, especially the pressure and/or temperature.

17. The method according to claim 16, wherein said one or more parent substances are present in the form of a powder that forms a liquid, hardenable metal foam (13) when exceeding or falling below a certain temperature and/or a certain pressure.
